(19) United States
(12) Patent Application Publication
(10) Pub. No.: US 2010/0129781 A1
(43) Pub. Date: May 27, 2010

(54) Electrical bronze acupuncture statue apparatus

(75) Inventors: Fu-Cheng Wang, Taipei (TW); Hsiao-Wu Wang, Taipei (TW)

Correspondence Address: BACON & THOMAS, PLLC, 625 SLATERS LANE, FOURTH FLOOR, ALEXANDRIA, VA, 22314-1176, US

(73) Assignee: National Taiwan University, Taipei (TW)

(21) Appl. No.: 12/382,151

(22) Filed: Mar. 10, 2009

(30) Foreign Application Priority Data
Nov. 21, 2008 (TW) 097145033

(51) Int. Cl. G09B 23/30

(52) U.S. Cl. 434/267

(57) ABSTRACT

The invention discloses the electrical bronze acupuncture statue apparatus that comprises the electrical elements, the sensors and the embedded system. The invention simulates the acupuncture points for practicing the traditional Chinese medicine treatment and provides the virtual results.

### BACKGROUND OF THE INVENTION

1. Field of the Invention

The invention relates to an acupuncture teaching and practicing apparatus, more particularly to an electrical bronze acupuncture statue apparatus.

2. Description of the Prior Art

The Emperor Jen-Jong has ordered Doctor Wang Wei-Yi of Imperial Academy to revise the medical books and check the acupuncture literatures in the period of Tensung in Northern Sung Dynasty of China. In Tensung 4 (1026), Doctor Wang Wei-Yi designed a bronze acupuncture statue, which could be used by operators to practice the accuracy for the identification of acupuncture points. Doctor Wang Wei-Yi drew the front view and side view of the human body according to the human shape, and marked the accurate positions of acupuncture points. Doctor Wang Wei-Yi wrote 3 volumes of medical books by collecting the clinical experiences and gathering all acupuncture theories, in which 657 acupuncture points were recorded. The acupuncture points were arranged by the combination of meridian points and human parts, which not only can make people to understand the meridian points system, but also can provide the demand for clinical acquisition of acupuncture points.

In addition, Doctor Wang Wei-Yi designed and casted two bronze acupuncture statues. The size of statue was similar to an adult person. The body is composed of a front part and a rear part. The organs were put in the cavity of hollow chest and abdomen. The positions and orientations of meridian points were casted on the surface of bronze statue, and a hole was drilled in each acupuncture point. When operators want to use the bronze statue to practice the acupuncture, he has to coat a layer of yellow wax on the bronze statue firstly, and fill mercury into the bronze statue, then use the needle to pierce points. If the piercing of needle is accurate, the mercury will flow out from the hole. Otherwise no mercury will flow out from the hole, which also shows the piercing of needle is inaccurate. It could be used to practice the accuracy for the identification of points or teaching and examination purposes. Thus, the bronze statue has already had the basic point positioning function.

However, since from several thousands years ago till right now, there is no advanced pseudo-bronze acupuncture statue developed for practicing the accuracy for the identification of acupuncture points or teaching and examination purposes. In order to provide the demand for the practice of acupuncture piercing, it is necessary to develop the related techniques of bronze acupuncture statue, so as to save the practicing time and cost and achieve the goal of promoting acupuncture piercing techniques.

### SUMMARY OF THE INVENTION

The invention discloses the electrical bronze acupuncture statue apparatus that comprises the electrical elements, the sensors and the embedded system. Its feature is to combine different sensors to simulate the acupuncture points, and to detect the points pierced by operators and the acupuncture skills (such as the order of piercing, the depth of needle, and the rotations of the needle, etc.).

When an operator is piercing or withdrawing the needle, the invention will employ the interrupt circuit to generate an external interrupt signal to drive the first chip, in order to carry out the scanning action to obtain the positioning function.

Then, the first chip will transfer the positioning sensor signals to the embedded system, to inform the embedded system about the needling point at present. The embedded system will process the information of positioning sensor signals, and send the processing result to the second chip. The second chip will detect other sensors in the specific acupuncture point according to the processing result, and the detecting signals will be sent back to the embedded system. The embedded system will carry out the interpretation of acupuncture conditions according to the detecting signals, and display the corresponding information on the display screen.

The invention employs the electronic system to detect the acupuncture skills of the operator. Thus, compared with old mechanical bronze acupuncture statue, it has the advantages of real-time responses and reliability.

The electrical bronze acupuncture statue of the invention can show the acupuncture conditions on the screen of the embedded system, so that the operator can understand the acupuncture skills. Furthermore, the program for the symptoms of diseases and relevant therapies can be written in the embedded system. After the operator inserts the needle, the screen can display the information whether the therapy is right or wrong, so as to achieve the goal of training.

In addition, the invention is equipped with the sensor module which can be dismantled. All sensors can be integrated into a disassemble sensor module, which can be replaced if required.

The invention employs the electronic sensing system to simulate the acupuncture points of the human body. Thus, compared with old mechanical bronze acupuncture statue, it has the advantages of reliability and convenience.

The invention combines the sensor module, which except the point positioning function, also has the functions for detecting the acupuncture skills of the operator.

The disease database written in the embedded system of the invention can record various diseases and relevant therapies, so that the operator not only can practice the techniques, but also can simulate the therapies by using the invention.

The advantage and spirit of the invention can be understood further by the following detail description of invention and attached Figures.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows the detailed schematic structure of a preferred embodiment of the invention.

FIG. 2A shows the schematic diagram of the point positioning sensor.

FIG. 2B shows the complete circuit of the point positioning sensor.

FIG. 3 shows the interrupt circuit of the sensor module.

FIG. 4 shows the control diagram of the chip of the invention.

FIG. 5 shows an embodiment for the point scanning circuit of the invention.

FIG. 6A shows an embodiment for the skill scanning circuit of the invention.

FIG. 6B shows the schematic diagram for the skill scanning circuit of the invention.

FIG. 7 shows the embodiment diagram for the scanning circuit of the invention.

FIG. 8 shows the detailed schematic structure of an embodiment of the invention.

### DESCRIPTION OF THE PREFERRED EMBODIMENT

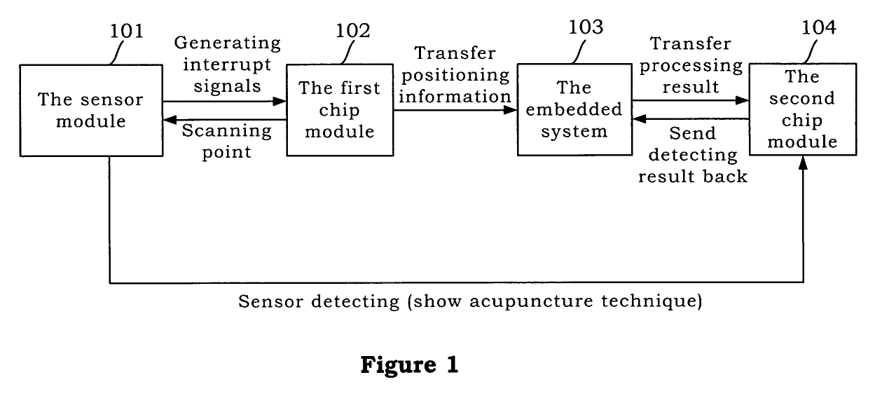

The invention relates to an electrical bronze acupuncture statue apparatus, which is composed of four components mainly. Its detail internal structure is shown in FIG. 1 and described as the followings:

As shown in FIG. 1, the invention comprises the sensor module 101, including the point positioning sensor 101A, the interrupt circuit 101B, and the skill detecting sensor 101C, having the point detecting function; the first chip module 102, including the first chip 102A and the first chip scanning circuit 102B, having the point positioning function; the embedded system 103 having the real-time data storage function and the prompt data processing function; and the second chip module 104 including the second chip 104A and the second chip scanning circuit 104B with the function of detecting skills. When the operator is piercing or withdrawing the needle, the interrupt circuit in the sensor module 101 will generate an external interrupt signal to activate the first chip module 102, in order to carry out the point scanning action to obtain the positioning information. Then, the first chip module 102 will transfer the positioning signals to the embedded system 103, to inform the embedded system 103 about the needling point at present. The embedded system 103 will process the positioning signals. Then as shown in FIG. 1, the embedded system 103 will send the processing result of positioning signals to the second chip module 104, which will detect other sensors in the specific point according to the processing result, and send back the detected signals to the embedded system 103. The embedded system 103 will carry out the interpretation of acupuncture conditions according to the detecting signals, and display the corresponding information on the display screen.

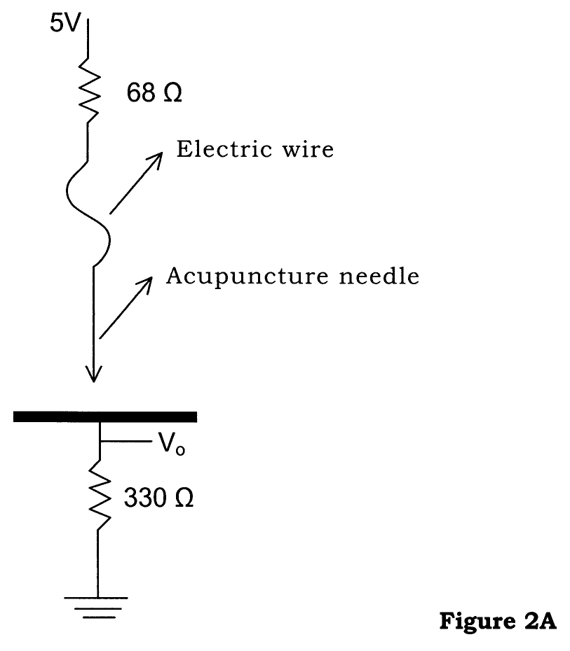

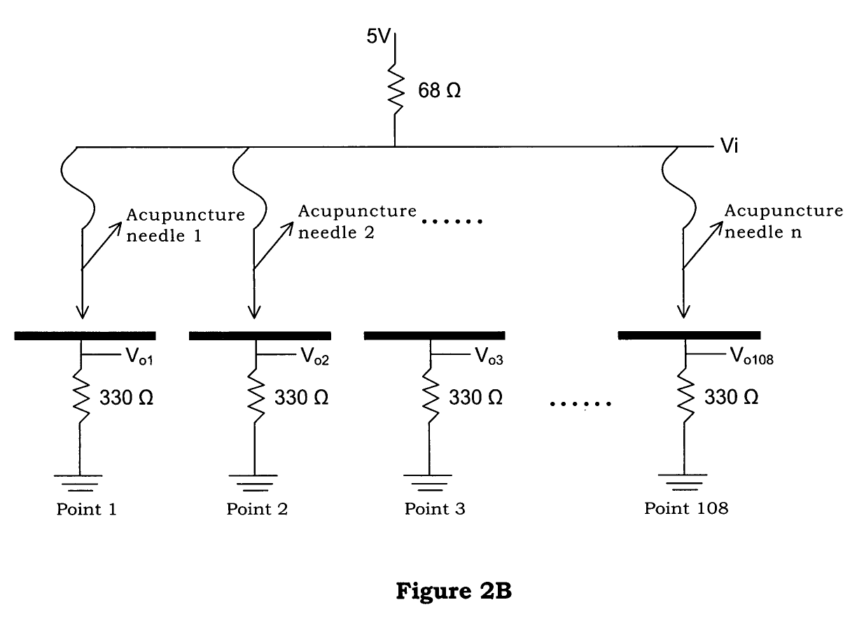

As shown in FIG. 2A, the sensor module 101 including the point positioning sensor 101A, that is the electronic switch sensor, which is formed by the copper foil tape and the electric wire on the needle. When the operator pierces the point, the circuit will be connected. The output voltage Vo will change from low voltage to high voltage, and then activate the interrupt circuit 101B to generate the interrupt signal, in order to drive the first chip 102A and start to scan the sensor module 101.

FIG. 2B shows the complete circuit of the point positioning sensor system. When the operator is piercing or withdrawing the needle, the output voltage Vox is changed to generate an interrupt signal, such that the points will be scanned. When the operator pierces the point x, the output voltage Vox is changed to high voltage. When the point is not pierced, it is kept at low voltage. Therefore, the voltage Vox can be used to determine whether the point is pierced or not. In addition, the contact sensor is adopted by the invention, and the magnetic type sensor and vision type sensor also can be adopted.

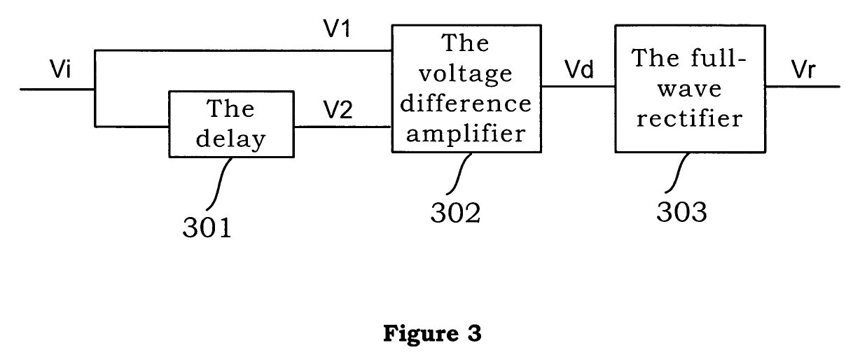

FIG. 3 shows the interrupt circuit 101B of the sensor module 101. In order to save electricity, the scanning circuit is in sleep mode ordinarily. When the operator is piercing or withdrawing the needle on the bronze acupuncture statue, the interrupt circuit will generate an interrupt signal to activate the first chip 102A and scanning circuit 102B in order to carry out the point scanning action, wherein the voltage change is shown by Vd=100(V1−V2) and the saturated voltage Vd is set as ±10V. The function of full-wave rectifier is to make Vr=|Vd|. When the operator is piercing or withdrawing the needle on the bronze acupuncture statue, the voltage Vi will be changed. Due to the charging or discharging of capacitor of delay 301, a voltage difference will be generated between V1 and V2. Then the voltage difference is amplified by the voltage difference amplifier 302 and rectified by the full-wave rectifier 303, such that the output voltage Vr is 5V (high voltage). After the charging or discharging of the capacitor is completed, there is no voltage difference between V1 and V2, and the output voltage Vr is 0V (low voltage). Thus a negative interrupt signal will be generated to activate the first chip 102A, in order to carry on the point scanning action.

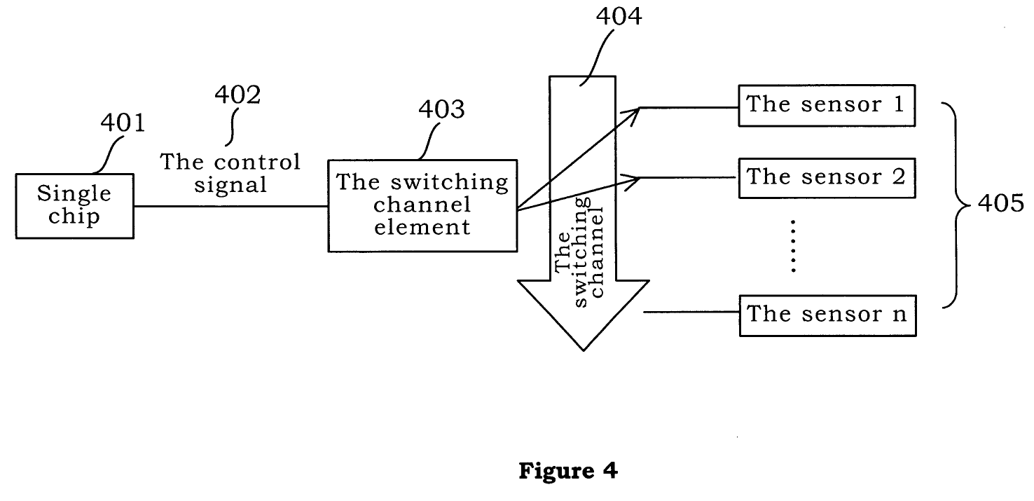

The chip 401 shown in FIG. 4 may be the first chip 102A or the second chip 104A. After the control signal 402 is emitted, the switching channel element 403 can be connected to different sensors in the sensor module 405 through the switching channel 404, in order to detect the signal of sensors.

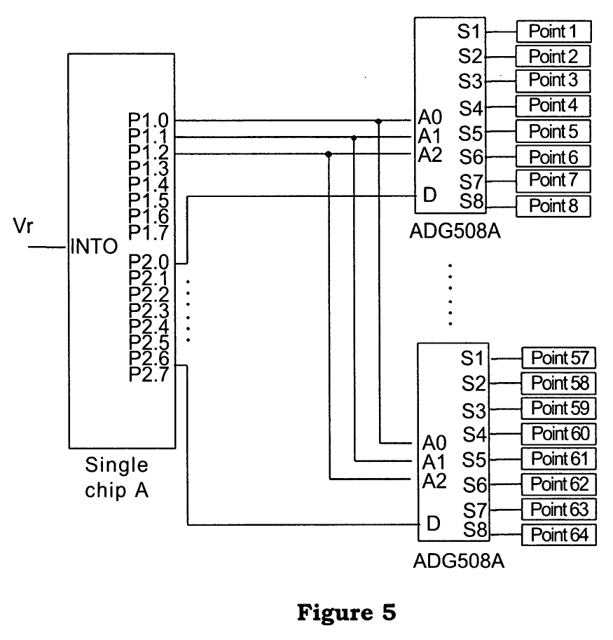

As shown in FIG. 5, the invention employs the first chip 102A and the scanning circuit 102B composed of a plurality of multiplexers ADG508A to form the first chip module 102. When Vr is changed from high voltage to low voltage due to the interrupt circuit, the first chip 102A will scan the points. The multiplexer ADG508A is an electronic multi-task switch with 8 channels, and the selection of channel is controlled by the pins A0, A1 and A2. When the first chip 102A receives the interrupt signal, P1.0, P1.1, and P1.2 of the first chip 102A can control the pins A0, A1 and A2 of multiplexer, and switch them to different acupuncture points in accordance with the command, and let the first chip 102A to detect the voltages of these points. After the first chip 102A detects the voltages of acupuncture points, it will determine which acupuncture point is needled in accordance with the level of voltages, and send the positioning signal to the embedded system 103 through RS232. When the embedded system 103 receives the signal, it will activate the second chip module 104 to detect the skill detecting sensor 101C at specified sensor module according to the signal of the first chip module 102.

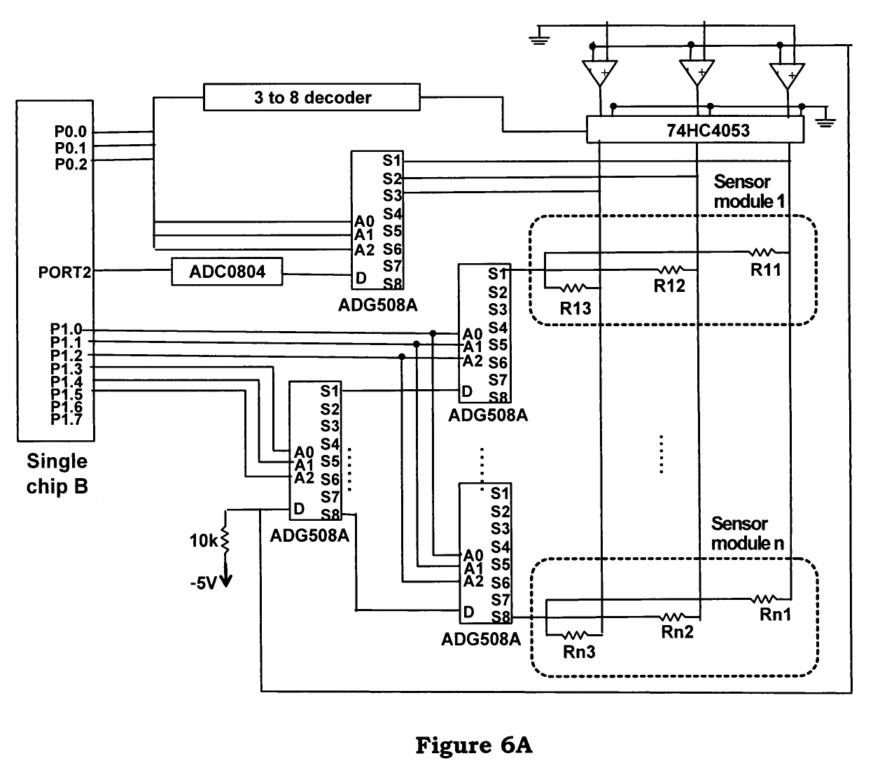

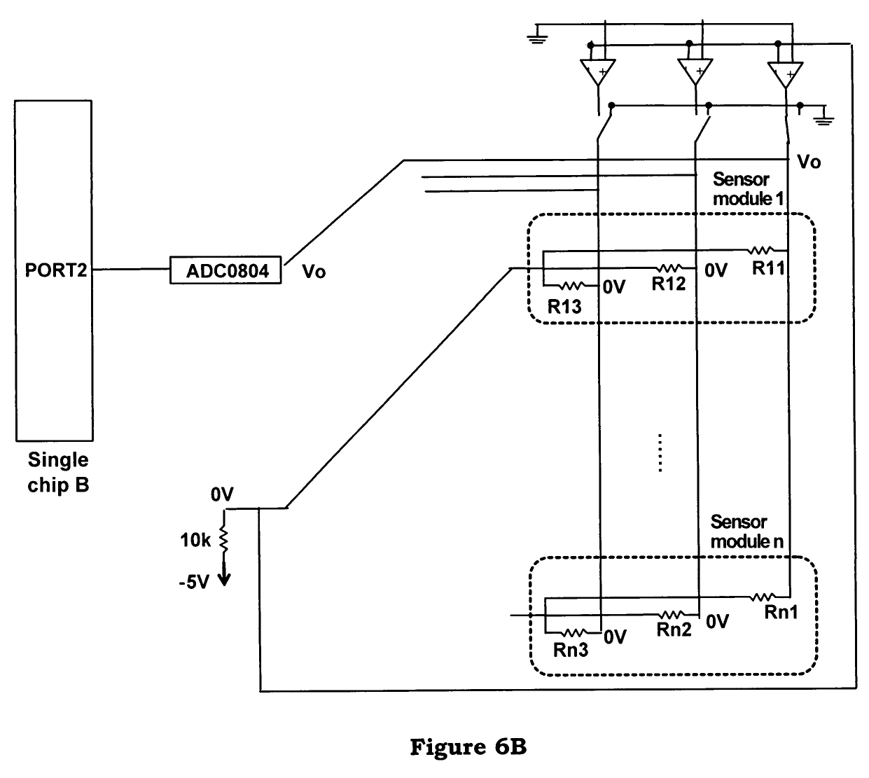

As shown in FIG. 6A, because the sensor module 101 usually contains many sensors, thus except the existing scanning circuit, a chip 74HC4053 with 3 electronic switches is added to eliminate the mutual interference problem of sensors in the sensor module 101. As for its realization, the second chip module 104 will switch the multiplexer ADG508A to the sensor module 101 of the point to be detected according to the embedded system. The chip 74HC4053 will connect the sensor to be detected to the operating amplifier to form an analog circuit. And the other electronic switches will be grounded to eliminate the mutual interference problem of sensors in the sensor module. Finally, the output voltage Vo is converted to the digital signal through the analog to digital converter (ADC) ADC0804.

As shown in FIG. 6B, as for the example of the first sensor R11 in the sensor module, the current through the other sensors is zero due to grounding, so the other sensors do not influence the result of Vo. In other word, the result of Vo is determined by the value of R11 completely. Then, the second chip module 104 will send this digital signal back to the embedded system 103. Thus the second chip module 104 has the function of transferring skill detecting signal, in order to recognize different acupuncture skills.

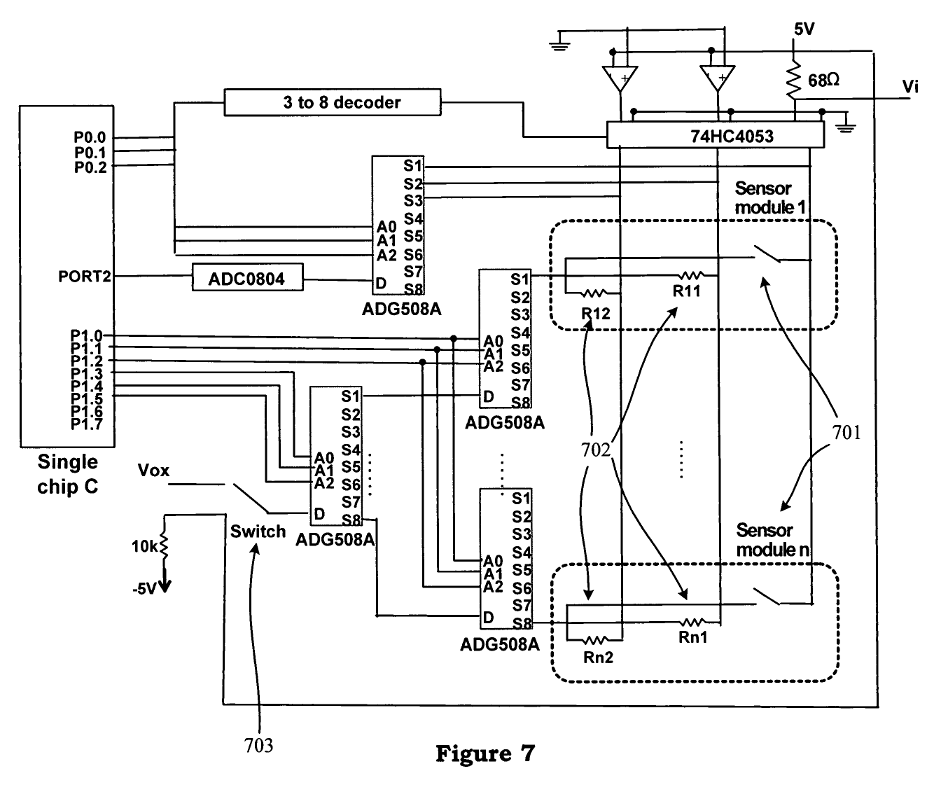

As shown in FIG. 7, the first chip module 102 and the second chip module 104 can be integrated into the third chip module 105 (including the third chip 105A and the third chip scanning circuit 105B). When no signal is changed, the positioning sensor 701 in every sensor module will be connected to 5V, and the skill detecting sensor 702 in sensor module will be grounded. The switch 703 will be connected to Vox to form a positioning scanning circuit equivalent to the one shown in FIG. 2B. And when the needling condition is changed, the third chip will receive an interrupt signal to carry out the point scanning action. Then, the third chip will make the positioning sensor in every sensor module to be grounded, and switch the switch 703 to connect to every operating amplifier in turn, in order to form a scanning circuit equivalent to the one shown in FIG. 6A to detect acupuncture skills.

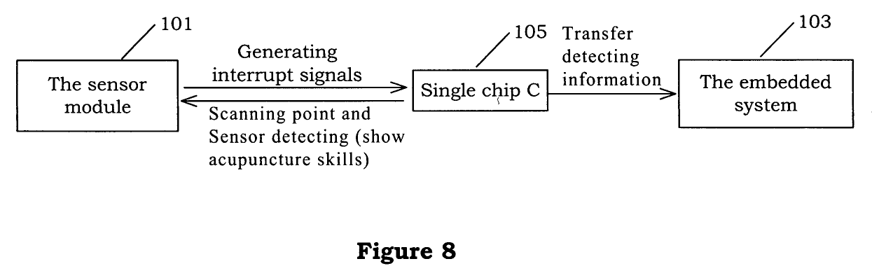

Finally, the whole integrated scheme is shown in FIG. 8. The third chip will send the positioning detecting signal and the skill detecting signal to the embedded system 103. The integrated scheme has the advantage of reducing number of chips and simplifying the communication of signals.

In the invention, the embedded system 103 adopts the A9M2410 chip, which is used for real-time data storing and for prompting data processing. It can process and judge the information of sensor sent from the first chip module 102 and the second chip module 104, and display the result on the screen clearly, so that the operator can understand his acupuncture skills more easily. Because it has strong processing abilities, the program of disease symptoms and corresponding therapies can be built in, in order to be practiced by the operator. The embodiments are illustrated using the following examples. First, sore throat has to be treated by piercing two points, namely the Heku point and Shaoshang point. And the order is the Heku point first and continued by the Shaoshang point. As the second example, cold is divided into wind-cold and wind-heat in Chinese medicine. To treat wind-cold, the points such as Liehchueh point, Heku point, Fengmen point, and Fengchih point can be acupunctured. On the other hand, to treat wind-heat mainly, the points such as Yuchi point, Chistse point, Chuchih point, Neiting point, Tachui point, and Fengchih point can be acupunctured.

The above-mentioned disease symptoms and corresponding therapies can be written into the database of the embedded system 103, so that the operator not only can practice the techniques, but also can practice the therapies of diseases. In addition, because the part of the embedded system 103 is only responsible for receiving the signals, processing information and displaying the results, thus the personal computer can be used to substitute the embedded system 103.

The invention relates to a method to use the electrical bronze acupuncture statue apparatus, comprising:

Firstly, the sensor module 101 emits an interrupt signal to activate the first chip module 102.

Then, the first chip module 102 scans the point positioning sensor in the sensor module 101.

Then, the first chip module 102 receives the positioning signal.

And then, the embedded system 103 carries out real-time data storage and prompt data processing for the positioning detecting signal.

Finally, the second chip module 104 receives commands from the embedded system and returns the skill-detecting signals to the embedded system, in order to form the method for using the electrical bronze acupuncture statue apparatus.

The feature of the invention is to use the electronic system and the embedded system 103 to process and judge the acupuncture motions of the operator, and display the result on the screen of the embedded system 103, so that the operator can understand his acupuncture skills. Furthermore, the disease symptoms and corresponding therapies can be written into the database of the embedded system 103, so that the information of therapies can be shown on the display screen at once upon the simulation therapy procedure conducted by the operator, so as to achieve the goal of training.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. An electrical bronze acupuncture statue apparatus, comprising:
a sensor module having a point detecting function;
a first chip module having a point positioning function;
an embedded system having a real-time data storage function and a prompt data processing function; and
a second chip module having a function for receiving a skill-detecting signal to form the electrical bronze acupuncture statue apparatus.

2. The apparatus according to claim 1, wherein the sensor module comprises:
a point positioning sensor;
an interrupt circuit; and
a skill detecting sensor.

3. The apparatus according to claim 2, wherein the point positioning sensor is selected from the group of consisting contact sensor, the magnetic sensor and the vision sensor.

4. The apparatus according to claim 1, wherein the first chip module comprises a first chip and a first chip scanning circuit.

5. The apparatus according to claim 1, wherein the embedded system comprises by a single chip.

6. The apparatus according to claim 1, wherein the embedded system can be achieved by a personal computer.

7. The apparatus according to claim 1, wherein the second chip module comprises a second chip and a second chip scanning circuit.

8. Method for using electrical bronze acupuncture statue apparatus, comprising:
a sensor module emitting an interrupt signal and transferring a positioning detecting signal to a first chip module;
the first chip module receiving the interrupt signal and the positioning detecting signal;
an embedded system for carrying out a real-time data storage and a prompt data processing for the positioning detecting signal; and
a second chip module receiving and transferring a skill-detecting signals to the embedded system in order to form the method for using the electrical bronze acupuncture statue apparatus.

9. The method according to claim 8, wherein the sensor module comprises:
a point positioning sensor;
an interrupt circuit; and
a skill detecting sensor.

10. The method according to claim 9, wherein the point positioning sensor is selected from the group consisting of contact sensor, the magnetic sensor and the vision sensor.

11. The method according to claim 8, wherein the first chip module comprises a first chip and a first chip scanning circuit.

12. The method according to claim 8, wherein the embedded system comprises a single chip.

13. The method according to claim 8, wherein the embedded system comprises a personal computer.

14. The method according to claim 8, wherein the second chip module comprises a second chip and a second chip scanning circuit.
